(19) United States
(12) Patent Application Publication
(10) Pub. No.: US 2014/0191996 A1
(43) Pub. Date: Jul. 10, 2014

(54) TOUCHPAD, DISPLAY APPARATUS, AND METHOD FOR CONTROLLING TOUCHPAD

(71) Applicant: SAMSUNG ELECTRONICS CO., LTD., Suwon-si (KR)

(72) Inventors: Je Sun HWANG, Bucheon-si (KR); Chang Soo NOH, Yongin-si (KR); Sang On CHOI, Suwon-si (KR)

(73) Assignee: SAMSUNG ELECTRONICS CO., LTD., Suwon-si (KR)

(21) Appl. No.: 14/147,094

(22) Filed: Jan. 3, 2014

(30) Foreign Application Priority Data
Jan. 4, 2013 (KR) 10-2013-0000984

(51) Int. Cl. G06F 3/041

(52) U.S. Cl. CPC G06F 3/041
USPC 345/173

(57) ABSTRACT

A touchpad including a proximity detector configured to generate a proximity event by detecting whether an object is close to a touch surface, a coordinate recognizer configured to select one from among a relative coordinate mapping mode and an absolute coordinate mapping mode based on the proximity event and to predict coordinates of a touch point to be touched by the object, using the selected coordinate mapping mode, and a controller configured to control output of information about the predicted coordinates, is disclosed. If an object is close to a touch surface of a touchpad, it is predicted that a user desires to select a target. In this case, interaction with the user may be reduced by predicting and displaying a location to be touched by the object based on proximity of the object.

### CROSS-REFERENCE TO RELATED APPLICATION

This application claims the benefit of Korean Patent Application No. 2013-0000984, filed on Jan. 4, 2013 in the Korean Intellectual Property Office, the disclosure of which is incorporated herein by reference.

### BACKGROUND

1. Field

Apparatuses and methods consistent with exemplary embodiments relate to a touchpad capable of improving touch recognition accuracy and speed, a display apparatus communicating with the touchpad, and a method for controlling the touchpad.

2. Description of the Related Art

Unlike previous analog devices, multimedia devices such as a smart TV, a set-top box, a digital video disc (DVD) player, a laptop computer, a personal digital assistant (PDA), and a mobile smart device (e.g., a smartphone) include a variety of applications in a graphical user interface (GUI) environment.

Applications in a multimedia device are selected due to a signal input using an input device such as an infrared (IR) remote controller or a touchpad, and execute a program when selected.

Here, an IR remote controller includes a plurality of buttons such as a direction button and a selection button, and a user selects an application while extending a menu window in a tree structure on a display of a multimedia device using the buttons of the IR remote controller.

When an application is manipulated using the IR remote controller, there are a large number of restrictions and much inconvenience.

In the case of a touchscreen in which a touchpad is formed on a display, manufacturing costs are raised because the size of the touchpad is increased in proportion to the size of the display, and inconvenience is caused because a user should get close to the touchscreen for manipulation.

For example, if a 70-inch plasma display panel (PDP) TV includes a touchscreen, high manufacturing costs are required and a user experiences inconvenience to touch spots over a large screen.

In the case of a laptop computer in which a touchpad is separate from a display and is used only as an input device, the touchpad functions as a mouse used to select one of the items displayed on the display.

In this case, if a finger of a user or a pen touches the touchpad, the touchpad inputs data corresponding to the touched location using a port driver included in an operating system of the computer, converts the input data into relative coordinate values using a mouse driver to recognize the coordinate values, and then moves a mouse pointer displayed on a screen of a monitor to correspond to the coordinate values using a display driver.

The above-described touchpad using the relative coordinate mapping scheme has a much smaller size than the display and thus requires a plurality of clutching operations to manipulate a cursor. Particularly, in the case of a device having a large display, for example, a smart TV, the clutching operations are a main cause of performance reduction with regard to manipulating a cursor on a screen.

To minimize the clutching operations, an absolute coordinate mapping scheme having a high control display (CD) gain is used in a touchpad.

Using the absolute coordinate mapping scheme, a user may instinctively and rapidly access an approximate location on a screen but may not easily achieve accurate selection of one of small and dense targets such as links to web pages.

### SUMMARY

Therefore, it is an aspect of the present exemplary embodiments to provide a touchpad to predict whether a user desires to select a target, based on proximity of an object close to a touch surface, a display apparatus to communicate with the touchpad to receive input information is n, and a method for controlling the touchpad.

It is another aspect of the present exemplary embodiments to provide a touchpad to predict the location of a touch point to be touched by an object, by automatically switching between an absolute coordinate mapping mode and a relative coordinate mapping mode based on proximity of the object, a display apparatus to communicate with the touchpad to receive input information, and a method for controlling the touchpad.

It is a further aspect of the present exemplary embodiments to provide a touchpad to display a predicted location of a touch point and a recognized location of the touch point on a display panel, a display apparatus to communicate with the touchpad to receive input information, and a method for controlling the touchpad.

Additional aspects of the exemplary embodiments will be set forth in part in the description which follows and, in part, will be obvious from the description, or may be learned by practice of the invention.

In accordance with one aspect of the exemplary embodiments, a touchpad includes a proximity detector configured to generate a proximity event by detecting whether an object is close to a touch surface; a coordinate recognizer configured to select one from among a relative coordinate mapping mode and an absolute coordinate mapping mode, based on the proximity event and to predict coordinates of a touch point to be touched by the object, using the selected coordinate mapping mode; and a controller configured to control output of information about the predicted coordinates, wherein, if the proximity event varies, the coordinate recognizer determines whether to switch the selected coordinate mapping mode based on the varied proximity event.

The coordinate recognizer obtains a proximity of the object based on the proximity event, compares the obtained proximity to a reference proximity, determines that a user desires to select a target if the obtained proximity is equal to or less than the reference proximity, and predicts the coordinates of the touch point in the absolute coordinate mapping mode.

The obtained proximity is a distance from the touch surface to the object in a perpendicular direction to the touch surface.

The coordinate recognizer calculates perpendicular movement of the object in the perpendicular direction for a certain time based on the proximity event, compares the calculated perpendicular movement to a reference perpendicular movement, and predicts the coordinates of the touch point in a relative coordinate mapping mode as a touch location of the object if the calculated perpendicular movement is equal to or greater than the reference perpendicular movement.

The coordinate recognizer determines that the touch surface is touched by the object if the obtained proximity is zero, and recognizes the touch point of the object.

The coordinate recognizer calculates parallel movement of the object in a parallel direction to the touch surface for a certain time based on the proximity event, compares the calculated parallel movement to a reference parallel movement, predicts the coordinates of the touch point in an absolute coordinate mapping mode if the calculated parallel movement is greater than the reference parallel movement, and predicts the coordinates of the touch point in a relative coordinate mapping mode if the calculated parallel movement is equal to or less than the reference parallel movement.

The touchpad may further include a touch detector configured to generate a touch event by detecting whether the touch surface is touched by the object, and the coordinate recognizer recognizes coordinates of the touch point of the object based on the touch event.

The touchpad may further include a communicator to transmit information about the predicted coordinates and the recognized coordinates to a display apparatus based on a command of the controller.

The coordinate recognizer gradually reduces a first control display (CD) gain.

The coordinate recognizer changes a first CD gain to a preset second CD gain.

In accordance with another aspect of the exemplary embodiments, a display apparatus includes a display panel; and a controller configured to control a size and location of a touch point displayed on the display panel based on information about a proximity between an object and a touch surface and coordinates of the touch point, which is transmitted from a touchpad, to determine whether the location of the touch point displayed on the display panel is within a recognition area of a target, and to select and control the target in the recognition area upon determining that the location of the touch point is within the recognition area of the target.

The controller transmits target selection failure information to the touchpad upon determining that the location of the touch point displayed on the display panel is out of the recognition area of the target. According to another aspect of the exemplary embodiments, there is provided a system having the above-disclosed display apparatus and touchpad.

In accordance with a further aspect of the exemplary embodiments, a method for controlling a touchpad includes determining whether an object close to a touch surface exists, based on a proximity event; obtaining a proximity based on the proximity event of the object upon determining that the object is close to the touch surface; comparing the obtained proximity to a reference proximity; if the obtained proximity is equal to or less than the reference proximity, predicting coordinates of a touch point in an absolute coordinate mapping mode and outputting the predicted coordinates of the touch point to a display apparatus calculating variation in the obtained proximity while predicting the coordinates of the touch point in the absolute coordinate mapping mode; automatically controlling switching of a coordinate mapping mode for prediction of the touch point between the absolute coordinate mapping mode and a relative coordinate mapping mode, by comparing the calculated variation in the proximity to a reference variation so as to predict the coordinates of the touch point; and outputting the coordinates of the touch point predicted correspondingly to the controlling of switching of the coordinate mapping mode, to the display apparatus.

The variation in the proximity may be related to perpendicular movement in a perpendicular direction to the touch surface and parallel movement in a parallel direction to the touch surface.

The parallel movement comprises movement in a first parallel direction to the touch surface, and movement in a second parallel direction perpendicular to the first parallel direction.

The automatic controlling of switching of the coordinate mapping mode by comparing the calculated variation in the proximity to the reference variation comprises: calculating perpendicular movement of the object in the perpendicular direction for a certain time; comparing the calculated perpendicular movement to a reference perpendicular movement; predicting the coordinates of the touch point in the relative coordinate mapping mode if the calculated perpendicular movement is equal to or greater than the reference perpendicular movement, and predicting the coordinates of the touch point in the absolute coordinate mapping mode if the calculated perpendicular movement is less than the reference perpendicular movement.

The automatic controlling of switching of the coordinate mapping mode by comparing the calculated variation in the proximity to the reference variation comprises: calculating parallel movement of the object in the parallel direction for a certain time; predicting the coordinates of the touch point in the absolute coordinate mapping mode if the calculated parallel movement is greater than the reference parallel movement, and predicting the coordinates of the touch point in the relative coordinate mapping mode if the calculated parallel movement is equal to or less than the reference parallel movement.

Switching of the absolute coordinate mapping mode to the relative coordinate mapping mode comprises gradually reducing a first control display (CD) gain.

The gradual reducing of the first CD gain comprises gradually reducing the first CD gain in proportion to the proximity between the touch surface and the object.

Switching of the absolute coordinate mapping mode to the relative coordinate mapping mode comprises changing a first CD gain to a preset second CD gain.

The method may further include determining whether the touch surface is touched by the object, based on a touch event; predicting the coordinates of the touch point of the object based on the touch event upon determining that the touch surface is touched by the object; and outputting the recognized coordinates to the display apparatus.

The method may further include re-predicting the coordinates of the touch point in the relative coordinate mapping mode if target selection failure information is received from the display apparatus.

The method may further include outputting the obtained proximity to the display apparatus.

### BRIEF DESCRIPTION OF THE DRAWINGS

These and/or other aspects of the exemplary embodiments will become apparent and more readily appreciated from the following description of the exemplary embodiments, taken in conjunction with the accompanying drawings of which:

FIG. 1 is a schematic diagram of a multimedia system including a touchpad and a display apparatus, according to an exemplary embodiment;

FIG. 2 is a block diagram of the multimedia system including the touchpad and the display apparatus, according to an exemplary embodiment;

FIG. 3 is a view illustrating absolute coordinate mapping between the touchpad and the display apparatus, according to an exemplary embodiment;

FIG. 4 is a flowchart of a method for controlling the touchpad, according to an exemplary embodiment;

FIGS. 5A, 5B, and 5C are views illustrating how to switch coordinate mapping modes of the touchpad and the display apparatus, according to an exemplary embodiment;

FIGS. 6A, 6B, and 6C are views illustrating a touch point on the touchpad and a touch point displayed on the display apparatus, according to an exemplary embodiment; and

FIG. 7 is a flowchart of a method for controlling the touchpad, according to another exemplary embodiment.

### DETAILED DESCRIPTION

Reference will now be made in detail to the exemplary embodiments, examples of which are illustrated in the accompanying drawings, wherein like reference numerals refer to like elements throughout.

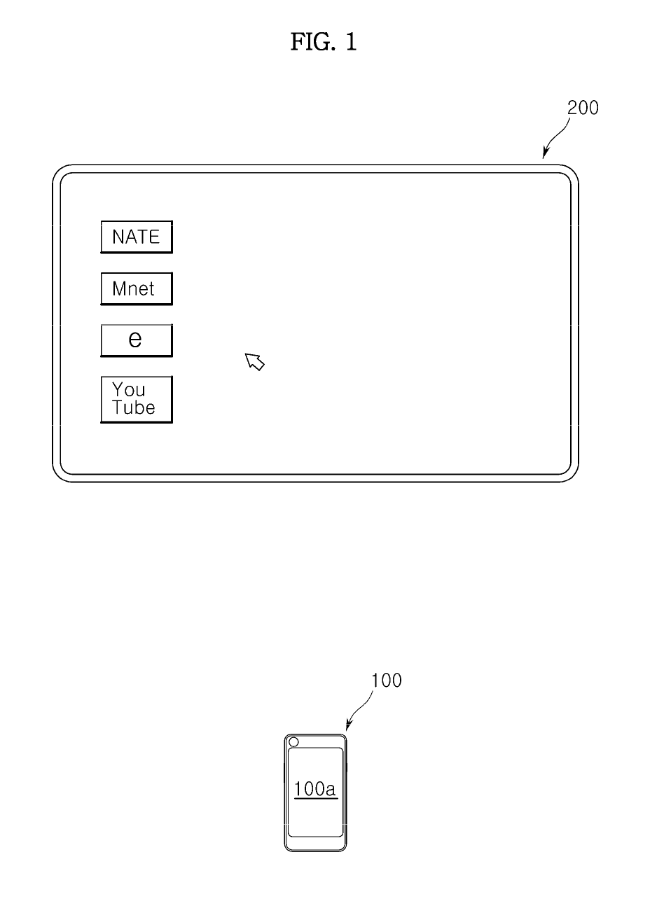

FIG. 1 is a schematic diagram of a multimedia system including a touchpad 100 and a display apparatus 200, according to an exemplary embodiment.

As an input device to input an operation command to the display apparatus 200, the touchpad 100 detects a proximity location of an object such as a finger or pen if the object is close to a touch surface 100a, and also detects a touch location of the object if the object touches the touch surface 100a.

The touchpad 100 transmits information about coordinates of the proximity location to the display apparatus 200 upon detecting the proximity location of the object, and also transmits information about coordinates of the touch location to the display apparatus 200 upon detecting the touch location of the object.

Due to mechanical and physical separation from the display apparatus 200, the touchpad 100 may easily manipulate an operation of the display apparatus 200 without being restricted by the location of a user who inputs an operation command.

The touchpad 100 may be included in the display apparatus 200 as necessary.

The touchpad 100 and the display apparatus 200 may be included in one main body, for example, a laptop computer, or a display panel of the display apparatus 200 and the touchpad 100 may be integrally formed, for example, with a touchscreen.

The touchpad 100 detects touch input using a resistive, capacitive, infrared (IR), optical, surface acoustic wave (SAW), or electric-field (E-field) distortion sensing scheme.

The display apparatus 200 is a device to display visual and stereoscopic image information.

The display apparatus 200 is a flat display device capable of reducing disadvantages of a cathode ray tube, for example, restrictive weight, volume, and installing space, and achieving a variety of excellent characteristics, for example, large screen, small thickness, and high quality.

The flat display device includes a liquid crystal display (LCD) device, an electroluminescent display (ELD) device, a field emission display (FED) device, a plasma display panel (PDP), a thin film transistor LCD (TFT-LCD) device, a flexible display device, an organic light-emitting diode (OLED), etc.

Among the above-mentioned devices, the LCD device is described as an example. As an LCD device, the display apparatus 200 may include a display panel, a diffuser plate, a light guide plate, a backlight unit, and a chassis.

The display panel is a pad to display an image of text, numbers, icons, etc. using liquid crystals.

The diffuser plate is a translucent pad to achieve uniform color and brightness over a whole screen by diffusing, along a display surface, light emitted from the backlight unit, and improves luminance of light emitted from the backlight unit before being supplied to the display panel. In other words, the diffuser plate enhances light from light-emitting diodes (LEDs) of the backlight unit and maintains uniform brightness over a whole display surface.

The light guide plate guides light from a light source of the backlight unit uniformly to the whole display panel, and the backlight unit emits light from the back or side of the display panel.

In other words, since liquid crystals themselves do not emit light, the display panel displays an image by adjusting the intensity and color of light emitted from the backlight unit.

The chassis is a pad to which driving modules required to display an image and to output sound are connected.

Examples of the driving modules include various printed circuit boards (PCBs) to control display of an image and output of sound, an interface device to be connected to an external device, a communication device to communicate with the external device, and a power device to supply operating power to each device.

The chassis is formed of a material capable of radiating heat well and having a high strength.

The display apparatus 200 may further include a bezel and cover to form the exterior of the display apparatus 200 and to accommodate the display panel, the diffuser plate, the light guide plate, the backlight unit, and the chassis. The bezel and cover may cover a non-display surface of the display panel and protect various components from external impact.

The display apparatus 200 displays an image on the display panel by controlling operation of the backlight unit, the display panel, etc.

The display apparatus 200 may be a monitor of a personal computer (PC) or a laptop computer, a mobile communication terminal, or a television. A smart television is an example of the display apparatus 200 in the current exemplary embodiment.

Here, the smart television is a television having functions of viewing television and accessing the Internet, and is a multifunction television providing a variety of services such as various applications (Apps), web surfing, video on demand (VOD), social network, game, content download, news, email, etc.

The display apparatus 200 displays icons to change channels and to control volumes related to viewing of television when a television function is used, and displays icons related to a plurality of Apps and content, execution information, etc. when functions other than the television function are used. Here, the icons displayed on the display apparatus 200 are targets to be selected by a user.

The display apparatus 200 displays the location of input of the user on an input device such as the touchpad 100 using a cursor or the like. If a target disposed on the location of the cursor is selected on the touchpad 100, the display apparatus 200 executes an operation corresponding to the selected target and displays an image related to execution information.

If the display apparatus 200 is a smart television, the touchpad 100 may function as a remote controller.

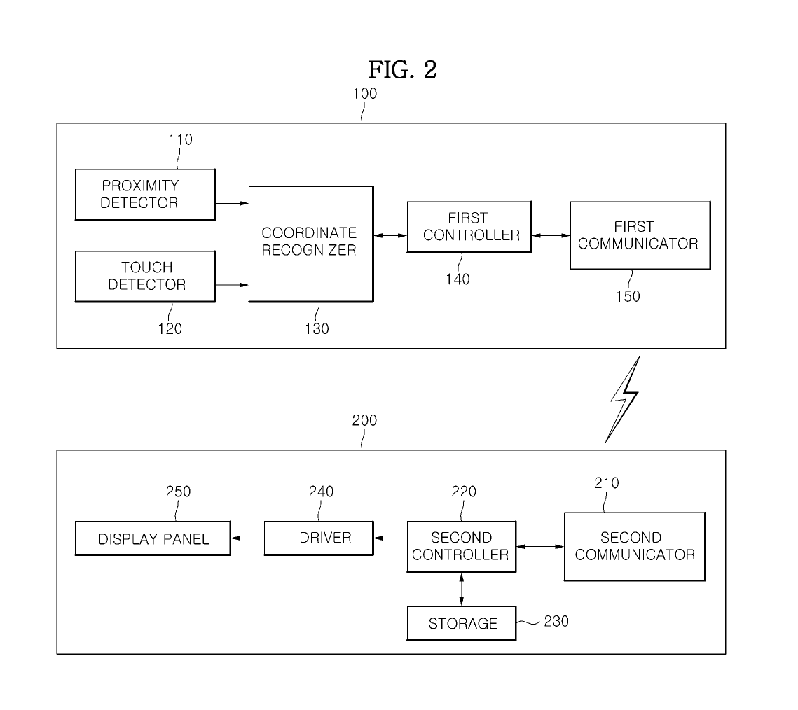

FIG. 2 is a block diagram of the multimedia system including the touchpad 100 and the display apparatus 200, according to an exemplary embodiment.

The touchpad 100 includes a proximity detection unit 110 (i.e., proximity detector), a touch detection unit 120 (i.e., touch detector), a coordinate recognition unit 130 (i.e., coordinate recognizer), a first controller 140, and a first communication unit 150 (i.e., first communicator).

The proximity detection unit 110 detects whether the object is close to the touch surface 100a of the touchpad 100 without directly contacting the touch surface 100a.

In other words, the proximity detection unit 110 generates a proximity event if the object is close to the touch surface 100a.

Here, the proximity event may be a signal to recognize a proximity between the touch surface 100a and the object, i.e., the distance between the touch surface 100a and the object, and location information of the object.

The proximity detection unit 110 included in the touchpad 100 may be formed of a plurality of sensor module arrays separate from the touch detection unit 120. In this case, the sensor modules may be IR or optical sensors.

Furthermore, if the touch detection unit 120 uses an IR or optical scheme, the proximity detection unit 110 may be integrated with the touch detection unit 120.

The touch detection unit 120 included in the touchpad 100 detects whether the object touches the touch surface 100a of the touchpad 100 by directly contacting the touch surface 100a and generates a touch event.

Here, the touch event is a signal to recognize the location of a touch point touched by the object.

The touch detection unit 120 may detect the location of the touch point using a resistive, capacitive, infrared (IR), optical, or surface acoustic wave (SAW) scheme.

The coordinate recognition unit 130 predicts coordinates of the touch point to be touched by the object, based on the proximity event transmitted from the proximity detection unit 110, and recognizes coordinates of the touch point touched by the object, based on the touch event transmitted from the touch detection unit 120.

The coordinate recognition unit 130 includes coordinate information corresponding to coordinates of the display panel of the display apparatus 200.

In other words, the coordinates of the touch point predicted and recognized by the coordinate recognition unit 130 correspond and are mapped to coordinates of the display panel of the display apparatus 200, and coordinate values corresponding to a location where the touch point is predicted or recognized are set in advance.

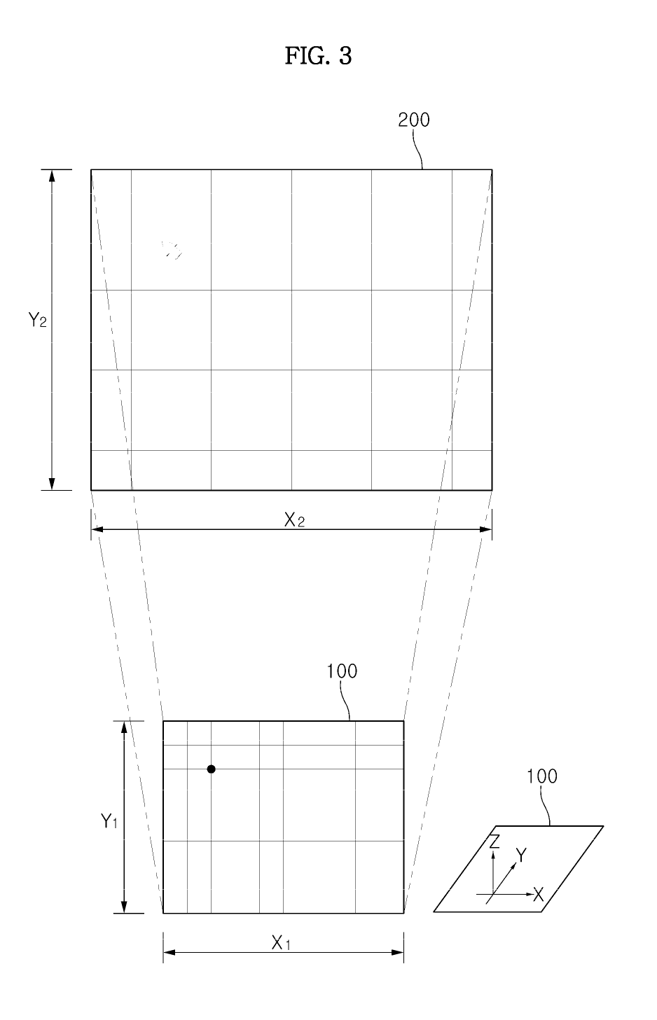

As illustrated in FIG. 3, a coordinate system of the touchpad 100 and a coordinate system of the display apparatus 200 may have the same number of coordinate values per coordinate axis, for example, n1 (e.g., 10) values on a horizontal axis and n2 (e.g. 8) values on a vertical axis.

In this case, the lengths of the horizontal and vertical axes of the touchpad 100 and the display apparatus 200 correspond to a ratio between the size of a touch recognition area of the touchpad 100 and the size of an image display area of the display panel of the display apparatus 200.

For example, if the size of the touch recognition area of the touchpad 100 is X1 on the horizontal axis and Y1 on the vertical axis, and if the size of the image display area of the display panel of the display apparatus 200 is X2 on the horizontal axis and Y2 on the vertical axis, a size ratio between the touchpad 100 and the display apparatus 200 corresponds to X1:X2 on the horizontal axis and Y1:Y2 on the vertical axis.

In this case, a ratio between the length of the horizontal axis of the touchpad 100 and the length of the horizontal axis of the display apparatus 200 is X1:X2, and a ratio between the length of the vertical axis of the touchpad 100 and the length of the vertical axis of the display apparatus 200 is Y1:Y2.

As such, when coordinate mapping is performed in an absolute coordinate mapping mode, if the object touches a location of coordinates (−3, 2) on the touchpad 100, a cursor is displayed at the location of coordinates (−3, 2) on the display apparatus 200.

Furthermore, the location of the curser displayed on the display apparatus 200 may be calculated based on coordinate values recognized on the touchpad 100 and the size ratio between the touchpad 100 and the display apparatus 200. The location may be calculated by the touchpad 100 or the display apparatus 200.

The above-described coordinate recognition unit 130 will now be described in detail.

The coordinate recognition unit 130 obtains proximity of the object based on the proximity event, compares the obtained proximity to reference proximity, and predicts coordinates of the touch point in the absolute coordinate mapping mode if the obtained proximity is equal to or less than the reference proximity.

Here, the proximity corresponding to the signal of the proximity event is set in advance.

The coordinate recognition unit 130 calculates variation in the obtained proximity while predicting coordinates of the touch point in the absolute coordinate mapping mode, compares the calculated variation in the proximity to a reference variation, and controls whether to switch coordinate mapping modes for prediction of the touch point based on a comparison result.

Here, the proximity is a distance from the touch surface 100a in a perpendicular direction to the touch surface 100a and is the distance between the touch surface 100a and the object. In other words, the proximity is a Z-axis value on the touch surface 100a. Furthermore, coordinates on a plane parallel to the touch surface 100a are set as X and Y coordinates.

Variation in the proximity includes perpendicular movement in a perpendicular direction to the touch surface 100a and parallel movement in a parallel direction to the touch surface 100a, and the parallel movement includes first parallel movement in a first parallel direction to the touch surface 100a and second parallel movement in a second parallel direction perpendicular to the first parallel direction.

In other words, the parallel movement relates to variation in X and Y coordinates based on movement along the X-axis and Y-axis.

The coordinate recognition unit 130 separately calculates the perpendicular movement, the first parallel movement, and the second parallel movement of the object that moves in the perpendicular direction, the first parallel direction, and the second parallel direction to the touch surface 100a for a certain time, based on the obtained proximity, and respectively compares the calculated perpendicular movement, the first parallel movement, and the second parallel movement to a reference perpendicular movement, first reference parallel movement, and second reference parallel movement.

If the calculated perpendicular movement is equal to or greater than the reference perpendicular movement, or if at least one of the calculated first parallel movement and the calculated second parallel movement is greater than the first reference parallel movement, the coordinate recognition unit 130 predicts coordinates of the touch point in the absolute coordinate mapping mode.

If the calculated perpendicular movement is equal to or greater than the reference perpendicular movement, and both of the calculated first parallel movement and the calculated second parallel movement are greater than the first reference parallel movement, the coordinate recognition unit 130 predicts coordinates of the touch point in the absolute coordinate mapping mode.

If the calculated perpendicular movement is equal to or greater than the reference perpendicular movement, if the calculated first parallel movement is equal to or less than the first reference parallel movement, and if the calculated second parallel movement is equal to or less than the second reference parallel movement, the coordinate recognition unit 130 predicts coordinates of the touch point in a relative coordinate mapping mode.

Otherwise, if the calculated perpendicular movement is less than the reference perpendicular movement, if the calculated first parallel movement is greater than the first reference parallel movement, or if the calculated second parallel movement is greater than the second reference parallel movement, the coordinate recognition unit 130 predicts coordinates of the touch point in the absolute coordinate mapping mode.

The coordinate recognition unit 130 reduces a control display (CD) gain to switch from the absolute coordinate mapping mode to the relative coordinate mapping mode, and increases the CD gain to switch from the relative coordinate mapping mode to the absolute coordinate mapping mode.

The CD gain is a gain to adjust a location variation of the cursor to be displayed on the display panel, in order to display the location of the touch point to be touched by the moving object.

In other words, the CD gain is a gain to adjust location variation of the cursor relative to specific movement of the object.

For example, if the object moves by 1 only on the X-axis when the cursor is displayed on the display panel in the absolute coordinate mapping mode, the cursor also moves by 1 on the X-axis. However, if the object moves by 1 only on the X-axis after the coordinate mapping mode is switched to the relative coordinate mapping mode and the CD gain is changed to 0.3, the cursor moves by 0.3 on the X-axis.

The coordinate recognition unit 130 gradually reduces the CD gain from a first CD gain to a second CD gain.

In this case, the CD gain is gradually reduced in proportion to the proximity between the touch surface 100a of the touchpad 100 and the object, i.e., the distance between the touch surface 100a of the touchpad 100 and the object.

The coordinate recognition unit 130 may reduce the CD gain from a first CD gain to a preset second CD gain.

Here, the first CD gain is an initially set reference gain, for example, about 1, and the second CD gain is a minimum gain, for example, about 0.3.

The coordinate recognition unit 130 recognizes coordinates of the touch point of the object if a touch of the object on the touch surface 100a is detected, and re-predicts the coordinates of the touch point by switching the coordinate mapping mode to the relative coordinate mapping mode if a coordinate mapping mode switching signal is received from the first controller 140.

The first controller 140 controls the first communication unit 150 to output information about the coordinates predicted based on the proximity event and information about the coordinates recognized based on the touch event, to the display apparatus 200.

If target selection failure information is received from the display apparatus 200, the first controller 140 transmits the coordinate mapping mode switching signal to the coordinate recognition unit 130 to predict coordinates of the touch point by switching to the relative coordinate mapping mode.

The first controller 140 controls the first communication unit 150 to output the obtained proximity to the display apparatus 200.

The first communication unit 150 is connected to the display apparatus 200 in a wired or wireless manner and communicates with the display apparatus 200.

The first communication unit 150 transmits information about coordinates of the touch point on the touchpad 100 to the display apparatus 200 based on a command of the first controller 140, and transmits information transmitted from the display apparatus 200, to the first controller 140.

The display apparatus 200 includes a second communication unit 210 (i.e., second communicator), a second controller 220, a storage 230, a driver 240, and a display panel 250.

The second communication unit 210 receives input information transmitted from the touchpad 100 via wired or wireless communication, and transmits the received input information to the second controller 220.

Here, the received input information is information about predicted coordinates of the touch point to be touched by the object, or information about recognized coordinates of the touch point touched by the object.

The second communication unit 210 transmits a target selection failure information to the touchpad 100 based on a command of the second controller 220.

The second controller 220 controls display of the touch point on the display panel 250 based on proximity and coordinate information of the touch point transmitted from the touchpad 100, and controls movement of the touch point on the display panel 250 based on variation in the coordinate information transmitted from the touchpad 100.

In this case, the second controller 220 adjusts the size of the touch point displayed in the display panel 250 based on the proximity between the object and the touch surface 100a.

For example, if the proximity between the touch surface 100a and the object is reduced, the size of the touch point displayed on the display panel 250 is also reduced.

Furthermore, the second controller 220 may control cursor shapes in such a manner that a cursor displayed when the proximity between the touch surface 100a and the object is greater than a reference proximity and a cursor displayed when the proximity is equal to or less than the reference proximity, are displayed in different shapes.

If the proximity is 0 or the object touches the touch surface 100a, the second controller 220 may adjust the size of the cursor to correspond to a touch area of the object.

Here, the proximity 0 refers to a distance 0 between the object and the touch surface 100a, i.e., a case that the object touches the touch surface 100a.

The second controller 220 determines whether a recognized location of the touch point transmitted from the touchpad 100 is within a recognition area of a target. If the recognized location of the touch point is within the recognition area of the target, the second controller 220 selects the target and executes operation of the selected target. Otherwise, if the recognized location of the touch point is out of the recognition area of the target, the second controller 220 determines that selection of the target is failed and controls transmission of target selection failure information.

The second controller 220 provides overall control to the display apparatus 200 based on input information of a user transmitted from the touchpad 100.

The storage 230 stores location information of various icons displayed on the display panel 250, and stores a coordinate value of every location of the display panel 250.

The driver 240 drives the display panel 250 to display an image based on a command of the second controller 220.

The display panel 250 displays an image signal of a broadcasting signal, various types of content information, and various icons.

In addition, the display panel 250 displays a cursor indicating an input location of information that the user desires to input.

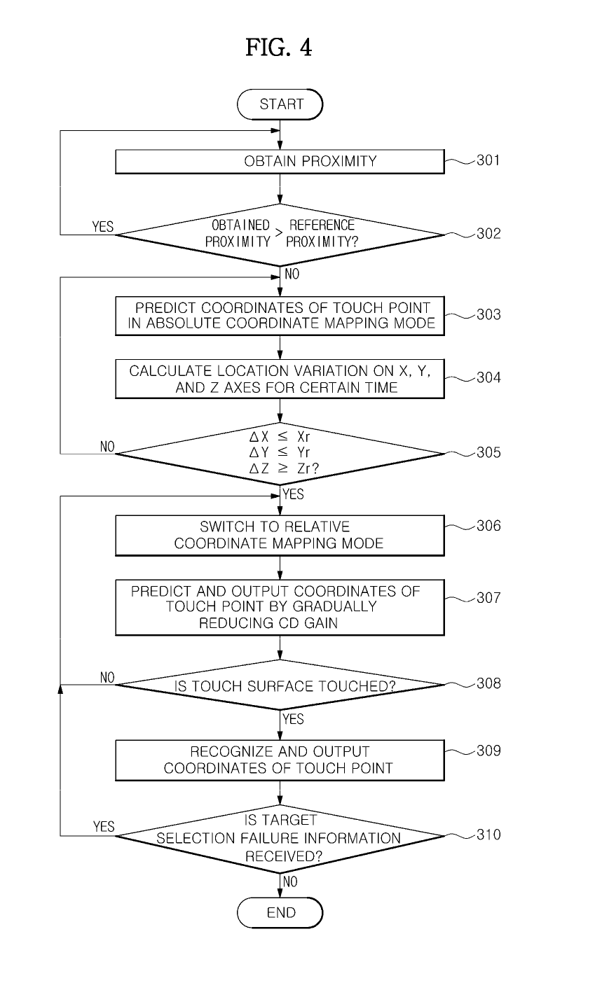

FIG. 4 is a flowchart of a method for controlling the touchpad 100, according to an exemplary embodiment. The method of FIG. 4 is described in conjunction with FIGS. 1, 2, 5A, 5B, and 5C.

The touchpad 100 determines whether the proximity detection unit 110 generates a proximity event.

Upon determining that the proximity detection unit 110 generates a proximity event, the touchpad 100 obtains a proximity between the touch surface 100a and the object, i.e., the distance between the touch surface 100a and the object, based on the generated proximity event (301).

Then, the touchpad 100 compares the obtained proximity to reference proximity (302). If the obtained proximity is equal to or less than the reference proximity, the touchpad 100 predicts coordinates of a touch point in an absolute coordinate mapping mode (303), and transmits information about the predicted coordinates of the touch point and the proximity of the object to the touch surface 100a, to the display apparatus 200. If the obtained proximity is greater than the reference proximity, operation 301 may be repeated.

In this case, the display apparatus 200 displays the touch point at a location corresponding to the predicted coordinates and adjusts the touch point to a size corresponding to the proximity. Here, the touch point may be displayed in a variety of shapes, for example, a circle or arrow.

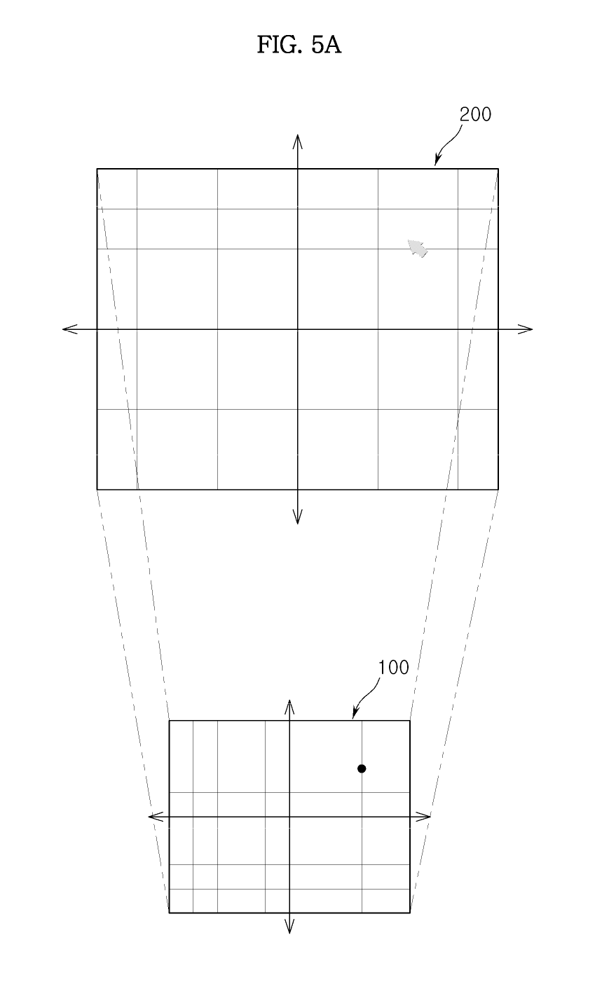

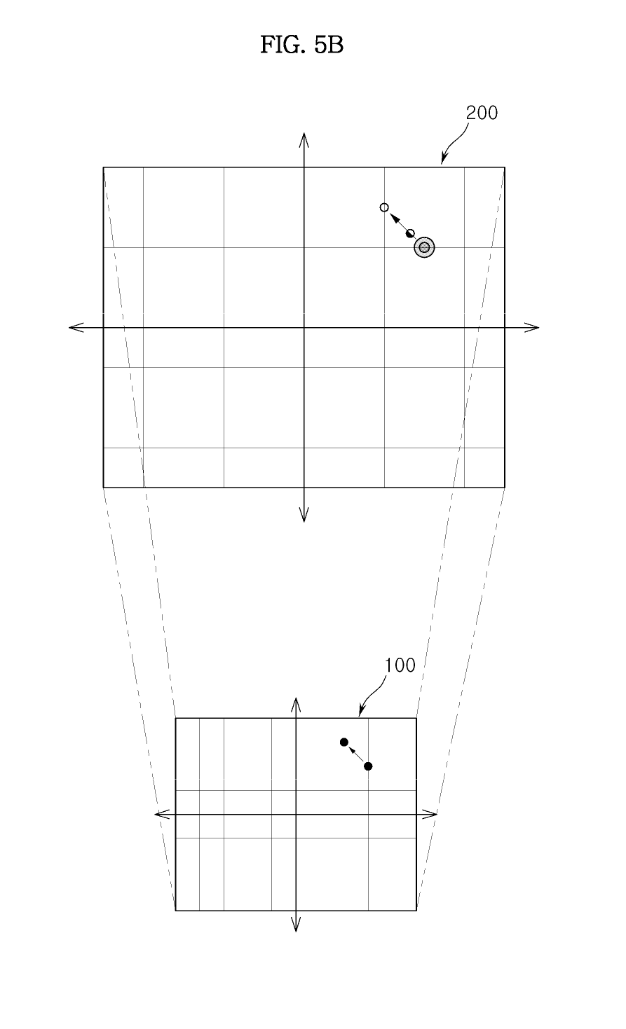

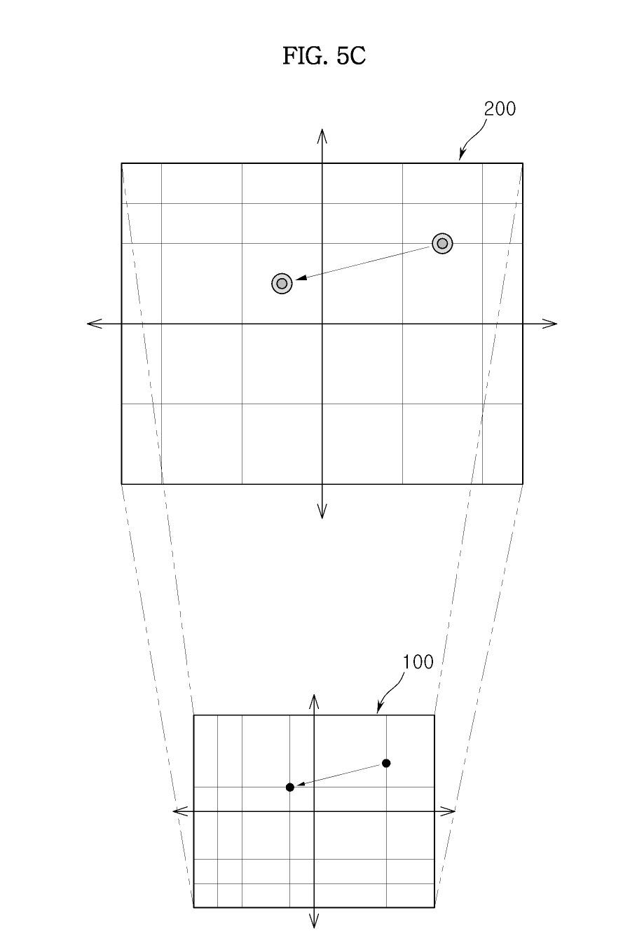

As illustrated in FIG. 5A, when coordinate mapping between the touchpad 100 and the display apparatus 200 is performed in the absolute coordinate mapping mode, if the object is close to a location of coordinates (3, 2) on the touch surface 100a of the touchpad 100, a cursor is displayed at a location of coordinates (3, 2) on the display apparatus 200.

Then, the touchpad 100 calculates location variation of the object close to the touch surface 100a for a certain time based on the proximity event while predicting coordinates of the touch point to be touched by the object in the absolute coordinate mapping mode (304).

Here, the location variation includes perpendicular movement of the object in a perpendicular direction to the touch surface 100a, and parallel movement of the object in a parallel direction to the touch surface 100a.

In other words, the touchpad 100 separately calculates perpendicular movement of the object close to the touch surface 100a in the perpendicular direction for a certain time, first parallel movement of the object in a first parallel direction to the touch surface 100a for the certain time, and second parallel movement of the object in a second parallel direction to the touch surface 100a for the certain time.

Here, the perpendicular movement is Z-axis movement ΔZ, the first parallel movement is X-axis movement ΔX, and the second parallel movement is Y-axis movement ΔY.

Optionally, the difference between maximum and minimum values among coordinate values detected for the certain time may be calculated as movement.

Then, the touchpad 100 compares the calculated location variation to reference location variation (305). A detailed description thereof will now be provided.

The touchpad 100 compares the calculated Z-axis movement ΔZ to reference perpendicular movement Zr, compares the calculated X-axis movement ΔX to first reference parallel movement Xr, and compares the calculated Y-axis movement ΔY to second reference parallel movement Yr.

If the calculated Z-axis movement ΔZ is equal to or greater than the reference perpendicular movement Zr, if the calculated X-axis movement ΔX is equal to or less than the first reference parallel movement Xr, and if the calculated Y-axis movement ΔY is equal to or less than the second reference parallel movement Yr, the touchpad 100 switches a coordinate mapping mode for prediction of the touch point from the absolute coordinate mapping mode to a relative coordinate mapping mode (306), and predicts coordinates of the touch point by gradually reducing a first CD gain to a second CD gain (307).

In this case, the first CD gain is reduced in proportion to the proximity (Z-axis value), i.e., the distance between the touch surface 100a and the object.

Here, the first CD gain is greater than the second CD gain.

Then, the touchpad 100 transmits information about the predicted coordinates of the touch point and the proximity of the object to the touch surface 100a, to the display apparatus 200.

In this case, the display apparatus 200 displays the touch point at a location of the display panel 250 corresponding to the predicted coordinates and adjusts the touch point to a size corresponding to the proximity of the object to the touch surface 100a. In other words, if the proximity of the object to the touch surface 100a is reduced, the size of the touch point displayed on the display apparatus 200 is also reduced.

A description thereof will now be provided with reference to FIG. 5B.

As illustrated in FIG. 5B, when coordinate mapping between the touchpad 100 and the display apparatus 200 is performed in the relative coordinate mapping mode, if the object moves by −1 on the X axis and by +1 on the Y axis when the touch point is displayed at a location of coordinates (3, 2) on the display apparatus 200, since the touch point to be displayed on the display apparatus 200 is mapped in the relative coordinate mapping mode, the touch point of the display panel 250 moves relative to the movement on the touchpad 100.

In this case, the location of the touch point of the display apparatus 200 is primarily predicted as coordinates (2, 3) and the primarily predicted coordinate values are predicted again and again based on a CD gain which is gradually reduced.

For example, assuming that the CD gain is gradually reduced from 1 to 0.9, 0.6, and 0.3 as the proximity is reduced, the coordinates of the touch point displayed on the display apparatus 200 are gradually changed from (2, 3) to (2.1, 2.9), (2.4, 2.6), and (2.7, 2.3).

In other words, as the first CD gain is gradually reduced to the second CD gain, i.e., 0.3, the coordinates of the touch point are ultimately predicted as (2.7, 2.3) and then the touch point is displayed at a location of coordinates (2.7, 2.3) on the display panel 250.

Furthermore, considering that a target is changeable before the object touches the touch surface 100a of the touchpad 100 or before the proximity between the touch surface 100a of the touchpad 100 and the object becomes 0, the location variation of the object is repeatedly calculated while performing coordinate mapping in the relative coordinate mapping mode, and the relative coordinate mapping mode is switched to the absolute coordinate mapping mode and the CD gain is increased if the proximity is increased or if the calculated parallel movement is greater than the reference parallel movement.

Otherwise, if the calculated Z-axis movement ΔZ is less than the reference perpendicular movement Zr, if the calculated X-axis movement ΔX is greater than the first reference parallel movement Xr, and if the calculated Y-axis movement ΔY is greater than the second reference parallel movement Yr, the touchpad 100 maintains the absolute coordinate mapping mode and predicts coordinates of the touch point in the absolute coordinate mapping mode (303). In this case, the CD gain is maintained as the first CD gain.

Then, the touchpad 100 transmits information about the predicted coordinates of the touch point and the proximity to the display apparatus 200.

In this case, the display apparatus 200 displays the touch point at a location corresponding to the predicted coordinates and adjusts the touch point to a size corresponding to the proximity. In other words, if the proximity is increased, the size of the touch point displayed on the display apparatus 200 is also increased.

A description thereof will now be provided with reference to FIG. 5C.

As illustrated in FIG. 5C, when coordinate mapping between the touchpad 100 and the display apparatus 200 is performed in the absolute coordinate mapping mode, if the location of the object close to the touch surface 100a of the touchpad 100 is changed from previous coordinates (3, 2) to current coordinates (2, 3), since the touch point is mapped to the display apparatus 200 in the absolute coordinate mapping mode, the location of the touch point displayed on the display apparatus 200 is changed from coordinates (3, 2) to coordinates (2, 3).

In other words, when coordinate mapping between the touchpad 100 and the display apparatus 200 is performed in the relative coordinate mapping mode, coordinates of the touch point to be displayed on the display apparatus 200 are predicted based on coordinates of the touch point displayed on the display apparatus 200 and movement of the object close to the touchpad 100. However, when coordinate mapping between the touchpad 100 and the display apparatus 200 is performed in the absolute coordinate mapping mode, the location of the touch point to be displayed on the display apparatus 200 is predicted based on the location of the object relative to the touchpad 100.

As described above, the touchpad 100 calculates location variation of the object based on a proximity event before the object contacts the touch surface 100a, and navigates the touch point to be touched by the object by switching coordinate mapping modes based on the calculated location variation.

Then, the touchpad 100 determines whether the touch surface 100a is touched by the object (308).

Here, whether the touch surface 100a is touched is determined based on whether the proximity is 0 or whether the touch detection unit 120 generates a touch event.

Then, upon determining that the touch surface 100a is touched by the object, the touchpad 100 recognizes coordinates of the touch point of the object and outputs the recognized coordinates of the touch point to the display apparatus 200 (309).

In this case, the display apparatus 200 checks coordinates of the display panel 250 corresponding to the recognized coordinates and displays the touch point at the checked coordinates.

The display apparatus 200 determines whether the location of the touch point displayed on the display panel 250 is within a recognition area of a target. Upon determining that the location of the touch point is within the recognition area of the target, the display apparatus 200 selects the target and executes operation of the selected target.

In this case, the display apparatus 200 adjusts the displayed touch point to a minimum size.

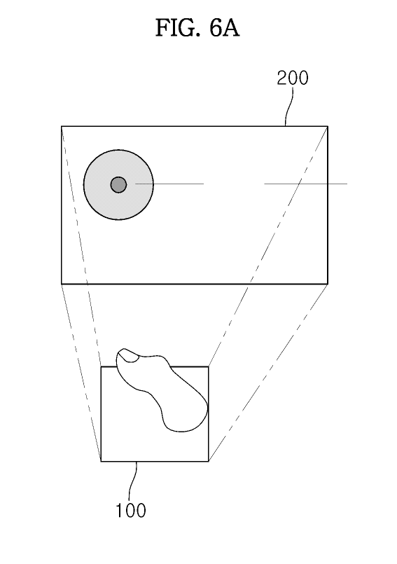

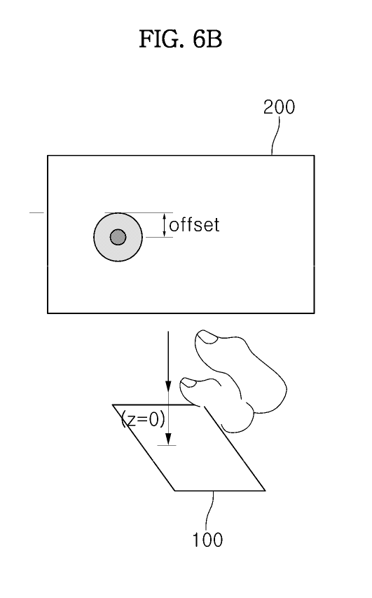

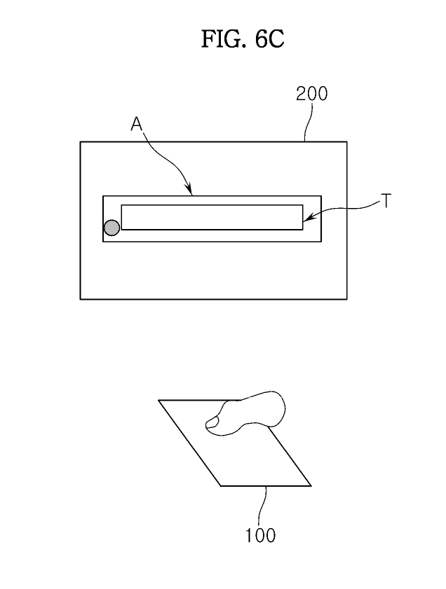

As illustrated in FIGS. 6A and 6B, the size of the touch point displayed on the display apparatus 200 is reduced as a finger, i.e., the object, is close to the touchpad 100, and the center of the displayed touch point is adjusted based on proximity of the object, location variation, and adjustment of a CD gain. As such, an offset of the touch point may be reduced.

In other words, a cursor offset generated due to operation characteristics (pivot) of a knuckle while the finger, which is close to the touch surface 100a, approaches the touchpad 100 to select a target to be pointed may be minimized by gradually switching from the absolute coordinate mapping mode to the relative coordinate mapping mode.

As illustrated in FIG. 6C, if the finger, i.e., the object, contacts the touchpad 100, the touch point displayed on the display apparatus 200 is adjusted to a minimum size.

In addition, it is determined whether the location of the touch point displayed on the display apparatus 200 is within a recognition area A of a target T. Upon determining that the location is within the recognition area A of the target T, operation of the target T is executed.

Otherwise, upon determining that the location of the touch point is out of the recognition area A of the target T, the display apparatus 200 transmits target selection failure information to the touchpad 100.

After information about the recognized coordinates of the touch point is transmitted to the display apparatus 200, the touchpad 100 determines whether target selection failure information is received from the display apparatus 200 (310). Upon determining that target selection failure information is received from the display apparatus 200, the touchpad 100 re-predicts the coordinates of the touch point to be touched by the object by switching the coordinate mapping mode to the relative coordinate mapping mode.

Furthermore, the touchpad 100 may re-predict the coordinates of the touch point to be touched by the object by switching the coordinate mapping mode to the absolute coordinate mapping mode based on the proximity of the object.

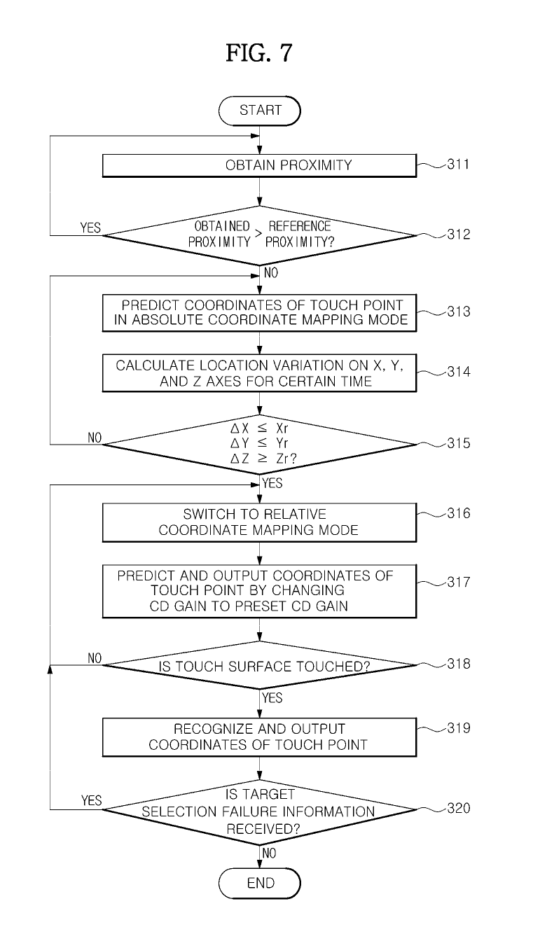

FIG. 7 is a flowchart of a method for controlling the touchpad 100, according to another exemplary embodiment.

The touchpad 100 determines whether the proximity detection unit 110 generates a proximity event.

Upon determining that the proximity detection unit 110 generates a proximity event, the touchpad 100 obtains a proximity, i.e., the distance between the touch surface 100a and the object, based on the generated proximity event (311).

Then, the touchpad 100 compares the obtained proximity to reference proximity (312). If the obtained proximity is equal to or less than the reference proximity, the touchpad 100 predicts coordinates of a touch point in an absolute coordinate mapping mode (313), and transmits information about the predicted coordinates of the touch point and the proximity to the display apparatus 200.

In this case, the display apparatus 200 displays the touch point at a location corresponding to the predicted coordinates and adjusts the touch point to a size corresponding to the proximity. Here, the touch point may be displayed in a variety of shapes, for example, a circle or arrow.

Then, the touchpad 100 calculates location variation of the object close to the touch surface 100a for a certain time based on the proximity event while predicting coordinates of the touch point to be touched by the object in the absolute coordinate mapping mode (314).

Then, the touchpad 100 compares the calculated location variations to reference location variations (315). A detailed description thereof will now be provided.

The touchpad 100 compares the calculated Z-axis movement ΔZ to reference perpendicular movement Zr, compares the calculated X-axis movement ΔX to first reference parallel movement Xr, and compares the calculated Y-axis movement ΔY to second reference parallel movement Yr.

If the calculated Z-axis movement ΔZ is equal to or greater than the reference perpendicular movement Zr, if the calculated X-axis movement ΔX is equal to or less than the first reference parallel movement Xr, and if the calculated Y-axis movement ΔY is equal to or less than the second reference parallel movement Yr, the touchpad 100 switches a coordinate mapping mode for prediction of the touch point from the absolute coordinate mapping mode to a relative coordinate mapping mode (316), and predicts coordinates of the touch point by gradually reducing a first CD gain to a second CD gain (317).

Here, the first CD gain is greater than the second CD gain.

Then, the touchpad 100 transmits information about the predicted coordinates of the touch point and the proximity to the display apparatus 200.

In this case, the display apparatus 200 displays the touch point at a location of the display panel 250 corresponding to the predicted coordinates and adjusts the touch point to a size corresponding to the proximity. In other words, if the proximity of the object to the touch surface 100a is reduced, the size of the touch point displayed on the display apparatus 200 is also reduced.

Furthermore, considering that a target is changeable before the object touches the touch surface 100a of the touchpad 100 or before the proximity between the touch surface 100a of the touchpad 100 and the object becomes 0, the location variation of the object is repeatedly calculated while performing coordinate mapping in the relative coordinate mapping mode, and the relative coordinate mapping mode is switched to the absolute coordinate mapping mode and a CD gain is changed from the second CD gain to the first CD gain if the proximity is increased or if the calculated parallel movement is greater than the reference parallel movement.

For example, if variation in the proximity is equal to or greater than reference variation, the CD gain is changed from 1 to 0.3. In this case, the coordinates of the touch point displayed on the display apparatus 200 are ultimately predicted as (2.7, 2.3) from (2, 3) and then the touch point is displayed at a location of coordinates (2.7, 2.3) on the display panel 250.

Otherwise, if the calculated Z-axis movement ΔZ is less than the reference perpendicular movement Zr, if the calculated X-axis movement ΔX is greater than the first reference parallel movement Xr, or the calculated Y-axis movement ΔY is greater than the second reference parallel movement Yr, the touchpad 100 maintains the absolute coordinate mapping mode and predicts coordinates of the touch point in the absolute coordinate mapping mode (313). In this case, the CD gain is maintained as the first CD gain.

Then, the touchpad 100 transmits information about the predicted coordinates of the touch point and the proximity to the display apparatus 200.

In this case, the display apparatus 200 displays the touch point at a location corresponding to the predicted coordinates and adjusts the touch point to a size corresponding to the proximity. In other words, if the proximity is increased, the size of the touch point displayed on the display panel 250 is also increased.

As described above, the touchpad 100 calculates location variation of the object based on a proximity event before the object contacts the touch surface 100a, and navigates the touch point to be touched by the object by switching coordinate mapping modes based on the calculated location variation.

Then, the touchpad 100 determines whether the touch surface 100a is touched by the object (318).

Here, whether the touch surface 100a is touched is determined based on whether the proximity is 0 or whether the touch detection unit 120 generates a touch event.

Then, upon determining that the touch surface 100a is touched by the object, the touchpad 100 recognizes coordinates of the touch point of the object and outputs the recognized coordinates of the touch point to the display apparatus 200 (319).

In this case, the display apparatus 200 checks coordinates of the display panel 250 corresponding to the recognized coordinates and displays the touch point at the checked coordinates.

The display apparatus 200 determines whether the location of the touch point displayed on the display panel 250 is within a recognition area of a target. Upon determining that the location of the touch point is within the recognition area of the target, the display apparatus 200 selects the target and executes operation of the selected target.

In this case, the display apparatus 200 adjusts the displayed touch point to a minimum size.

It is determined whether the location of the touch point displayed on the display apparatus 200 is within a recognition area A of a target T. Upon determining that the location is within the recognition area A of the target T, operation of the target T is executed.

Otherwise, upon determining that the location of the touch point is out of the recognition area A of the target T, the display apparatus 200 transmits target selection failure information to the touchpad 100.

After information about the recognized coordinates of the touch point is transmitted to the display apparatus 200, the touchpad 100 determines whether target selection failure information is received from the display apparatus 200 (320). Upon determining that target selection failure information is received from the display apparatus 200, the touchpad 100 re-predicts the coordinates of the touch point to be touched by the object by switching the coordinate mapping mode to the relative coordinate mapping mode.

Furthermore, the touchpad 100 may re-predict the coordinates of the touch point to be touched by the object by switching the coordinate mapping mode to the absolute coordinate mapping mode based on the proximity of the object.

As is apparent from the above description, if an object is close to a touch surface of a touchpad, it is predicted that a user desires to select a target. In this case, interaction with the user may be reduced by predicting and displaying a location to be touched by the object based on proximity of the object.

When the location to be touched by the object is predicted, since the location of a touch point is predicted by automatically switching a coordinate mapping mode to an absolute coordinate mapping mode or a relative coordinate mapping mode based on the proximity of the object and then is displayed on a display panel, a cursor may rapidly move on the display panel and one of small and adjacent link selection areas may be easily selected.

Particularly, when operation of a large display apparatus is manipulated using the touchpad, rapid manipulation may be achieved and one of small and adjacent link selection areas may be easily selected.

In addition, when three-dimensional motion of the object is graphically displayed on the display panel, a cursor offset may be minimized.

Specifically, if a finger is used as the object, since a CD gain is gradually changed while the finger approaches the touchpad to select a pointed target when the finger is close to the touch surface, a cursor offset generated due to operation characteristics (pivot) of a knuckle and confusion in use due to abrupt mode switching may be minimized.

Furthermore, since a coordinate system of a cursor is gradually changed while the object is selecting a target, incorrect target selection may be minimized.

Besides, since there is no need to additionally learn how to manually switch a coordinate mapping mode for recognition of the location of the touch point between a relative coordinate mapping mode and an absolute coordinate mapping mode, the touchpad may be easily used.

Although a few exemplary embodiments have been shown and described, it would be appreciated by those skilled in the art that changes may be made in these exemplary embodiments without departing from the principles and spirit of the invention, the scope of which is defined in the claims and their equivalents.

What is claimed is:

1. A touchpad comprising:
a proximity detector configured to generate a proximity event by detecting whether an object is close to a touch surface;
a coordinate recognizer configured to select one from among a relative coordinate mapping mode and an absolute coordinate mapping mode, based on the proximity event and to predict coordinates of a touch point to be touched by the object, using the selected coordinate mapping mode; and
a controller configured to control output of information about the predicted coordinates,
wherein, if the proximity event varies, the coordinate recognizer determines whether to switch the selected coordinate mapping mode based on the varied proximity event.

2. The touchpad according to claim 1, wherein the coordinate recognizer obtains a proximity of the object based on the proximity event, compares the obtained proximity to a reference proximity, determines that a user desires to select a target if the obtained proximity is equal to or less than the reference proximity, and predicts the coordinates of the touch point in the absolute coordinate mapping mode.

3. The touchpad according to claim 2, wherein the obtained proximity is a distance from the touch surface to the object in a perpendicular direction to the touch surface.

4. The touchpad according to claim 3, wherein the coordinate recognizer calculates perpendicular movement of the object in the perpendicular direction for a certain time based on the proximity event, compares the calculated perpendicular movement to a reference perpendicular movement, and predicts the coordinates of the touch point in a relative coordinate mapping mode as a touch location of the object if the calculated perpendicular movement is equal to or greater than the reference perpendicular movement.

5. The touchpad according to claim 2, wherein the coordinate recognizer determines that the touch surface is touched by the object if the obtained proximity is zero, and recognizes the touch point of the object.

6. The touchpad according to claim 1, wherein the coordinate recognizer calculates parallel movement of the object in a parallel direction to the touch surface for a certain time based on the proximity event, compares the calculated parallel movement to a reference parallel movement, predicts the coordinates of the touch point in an absolute coordinate mapping mode if the calculated parallel movement is greater than the reference parallel movement, and predicts the coordinates of the touch point in a relative coordinate mapping mode if the calculated parallel movement is equal to or less than the reference parallel movement.

7. The touchpad according to claim 1, further comprising a touch detector configured to generate a touch event by detecting whether the touch surface is touched by the object,
wherein the coordinate recognizer recognizes coordinates of the touch point of the object based on the touch event.

8. The touchpad according to claim 7, further comprising a communicator configured to transmit information about the predicted coordinates and the recognized coordinates to a display apparatus based on a command of the controller.

9. The touchpad according to claim 1, wherein the coordinate recognizer gradually reduces a first control display (CD) gain.

10. The touchpad according to claim 1, wherein the coordinate recognizer changes a first CD gain to a preset second CD gain.

11. A display apparatus comprising:
a display panel; and
a controller configured to control a size and location of a touch point displayed on the display panel based on information about a proximity between an object and a touch surface and coordinates of the touch point, which is transmitted from a touchpad, to determine whether the location of the touch point displayed on the display panel is within a recognition area of a target, and to select and control the target in the recognition area upon determining that the location of the touch point is within the recognition area of the target.

12. The display apparatus according to claim 11, wherein the controller transmits target selection failure information to the touchpad upon determining that the location of the touch point displayed on the display panel is out of the recognition area of the target.

13. A method for controlling a touchpad, the method comprising:
determining whether an object close to a touch surface exists, based on a proximity event;
obtaining a proximity based on the proximity event of the object upon determining that the object is close to the touch surface;
comparing the obtained proximity to a reference proximity;
if the obtained proximity is equal to or less than the reference proximity, predicting coordinates of a touch point in an absolute coordinate mapping mode and outputting the predicted coordinates of the touch point to a display apparatus;
calculating variation in the obtained proximity while predicting the coordinates of the touch point in the absolute coordinate mapping mode;
automatically controlling switching of a coordinate mapping mode for prediction of the touch point between the absolute coordinate mapping mode and a relative coordinate mapping mode, by comparing the calculated variation in the proximity to a reference variation so as to predict the coordinates of the touch point; and
outputting the coordinates of the touch point predicted correspondingly to the controlling of switching of the coordinate mapping mode, to the display apparatus.

14. The method according to claim 13, wherein the variation in the proximity relates to perpendicular movement in a perpendicular direction to the touch surface and parallel movement in a parallel direction to the touch surface.

15. The method according to claim 14, wherein the parallel movement comprises movement in a first parallel direction to the touch surface, and movement in a second parallel direction perpendicular to the first parallel direction.

16. The method according to claim 14, wherein the automatic controlling of switching of the coordinate mapping mode by comparing the calculated variation in the proximity to the reference variation comprises:
calculating perpendicular movement of the object in the perpendicular direction for a certain time;
comparing the calculated perpendicular movement to a reference perpendicular movement;
predicting the coordinates of the touch point in the relative coordinate mapping mode if the calculated perpendicular movement is equal to or greater than the reference perpendicular movement; and
predicting the coordinates of the touch point in the absolute coordinate mapping mode if the calculated perpendicular movement is less than the reference perpendicular movement.

17. The method according to claim 14, wherein the automatic controlling of switching of the coordinate mapping mode by comparing the calculated variation in the proximity to the reference variation comprises:
calculating parallel movement of the object in the parallel direction for a certain time;
predicting the coordinates of the touch point in the absolute coordinate mapping mode if the calculated parallel movement is greater than the reference parallel movement; and
predicting the coordinates of the touch point in the relative coordinate mapping mode if the calculated parallel movement is equal to or less than the reference parallel movement.

18. The method according to claim 13, wherein switching of the absolute coordinate mapping mode to the relative coordinate mapping mode comprises gradually reducing a first control display (CD) gain.

19. The method according to claim 18, wherein the gradual reducing of the first CD gain comprises gradually reducing the first CD gain in proportion to the proximity between the touch surface and the object.

20. The method according to claim 13, wherein switching of the absolute coordinate mapping mode to the relative coordinate mapping mode comprises changing a first CD gain to a preset second CD gain.

21. The method according to claim 13, further comprising:
determining whether the touch surface is touched by the object, based on a touch event;
predicting the coordinates of the touch point of the object based on the touch event upon determining that the touch surface is touched by the object; and
outputting the recognized coordinates to the display apparatus.

22. The method according to claim 21, further comprising re-predicting the coordinates of the touch point in the relative coordinate mapping mode if target selection failure information is received from the display apparatus.

23. The method according to claim 13, further comprising outputting the obtained proximity to the display apparatus.

24. A system of controlling a display apparatus with a touchpad, the system comprising:
a touchpad; and
a display apparatus,
wherein the touchpad comprises:
a proximity detector configured to generate a proximity event by detecting whether an object is close to a touch surface;
a coordinate recognizer configured to select one from among a relative coordinate mapping mode and an absolute coordinate mapping mode, based on the proximity event and to predict coordinates of a touch point to be touched by the object, using the selected coordinate mapping mode; and
a controller configured to control output of information about the predicted coordinates,
wherein, if the proximity event varies, the coordinate recognizer determines whether to switch the selected coordinate mapping mode based on the varied proximity event,
and wherein the display apparatus comprises:
a display panel; and
a controller configured to control a size and location of a touch point displayed on the display panel based on information about a proximity between an object and a touch surface and coordinates of the touch point, which is transmitted from a touchpad, to determine whether the location of the touch point displayed on the display panel is within a recognition area of a target, and to select and control the target in the recognition area upon determining that the location of the touch point is within the recognition area of the target.
